(19) United States
(12) Patent Application Publication
(10) Pub. No.: US 2026/0351483 A1
(43) Pub. Date: Nov. 5, 2026

(54) ELECTROLYTIC CAPACITOR AND PRODUCTION METHOD THEREFOR

(71) Applicant: Panasonic Intellectual Property Management Co., Ltd., Osaka (JP)

(72) Inventors: Shintaro WAKIYAMA, YAMAGUCHI KEN (JP); Hiroyuki NAKAKI, YAMAGUCHI KEN (JP); Shumpei MATSUSHITA, YAMAGUCHI KEN (JP); Kazuo KAWAHITO, OSAKA FU (JP)

(21) Appl. No.: 19/168,673

(22) PCT Filed: Mar. 28, 2024
(86) PCT No.: PCT/JP2024/012853

§ 371 Date: Sep. 24, 2025

(30) Foreign Application Priority Data
Mar. 29, 2023 (JP) 2023-053815

(51) Int. Cl. H01G 9/008; H01G 9/00; H01G 9/10; H01G 9/15

(52) U.S. Cl. CPC H01G 9/008; H01G 9/0036; H01G 9/10; H01G 9/15

(57) ABSTRACT

An electrolytic capacitor includes a first electrode, a second electrode, a container, and a sealing member. The first electrode has a first electrode foil, two or more first internal leads, and a first external lead. A part of each of the two or more first internal leads is overlapped with each other, forming a stacked part. The first external lead has a first portion, a second portion, and a third portion. The first portion has a top part crimped onto a first surface of the stacked part, the second portion is penetrated through the stacked part, and the third portion is protruded from a second surface opposite to the first surface of the stacked part and penetrated through the sealing member. The second portion is in contact with the inner peripheral surface of the stacked part.

### CROSS REFERENCE TO RELATED APPLICATION

The present disclosure claims priority with respect to the Japanese Patent Application No. 2023-053815 filed on Mar. 29, 2023, and the entire content of the patent application is incorporated herein by reference into the present specification.

### DESCRIPTION

### Technical Field

The present invention relates to an electrolytic capacitor and a method for producing the same.

### Background Art

Patent Literature 1 proposes “a method for producing an electrolytic capacitor having a first electrode and a second electrode, the method including: a first connection step of connecting a first internal lead having a foil shape to a first electrode foil; a second connection step of, after the first connection step, connecting a first external lead having a rod shape to the first internal lead, to obtain the first electrode; an insertion step of, after the second connection step, inserting the first external lead into an insertion hole of a sealing member; a housing step of housing the first electrode and the second electrode into a container; and a sealing step of, after the housing step, closing an opening of the container with the sealing member.”

### CITATION LIST

### Patent Literature

Patent Literature 1: International Publication WO2021/172440

### SUMMARY OF INVENTION

### Technical Problem

Patent Literature 1 discloses that “the first internal lead has a through-hole, and in the second connection step, after the first external lead is inserted into the through-hole, the first internal lead is pressed from both principal surfaces, to crush one of end parts of the first external lead, thereby to fix the first external lead to the first internal lead.”

According to the proposal in Patent Literature 1, however, due to the lack of consideration to the connection resistance between the first external lead and the first internal lead, the equivalent series resistance (ESR) cannot be sufficiently reduced, and it is difficult to increase the allowable value of the ripple current.

### Solution to Problem

One aspect of the present invention relates to an electrolytic capacitor, including: a first electrode, a second electrode, a container housing the first electrode and the second electrode, and a sealing member closing an opening of the container, wherein: the first electrode has a first electrode foil, two or more first internal leads connected to the first electrode foil, and a first external lead connected to the two or more first internal leads; a part of each of the two or more first internal leads is overlapped with each other, forming a stacked part; the first external lead has a first portion, a second portion continuous with the first portion, and a third portion continuous with the second portion; the first portion has a top part crimped onto a first surface of the stacked part; the second portion is penetrated through the stacked part; the third portion is protruded from the second surface opposite to the first surface of the stacked part and penetrated through the sealing member; and the second portion is in contact with an inner peripheral surface of the stacked part.

Another aspect of the present invention relates to a method for producing an electrolytic capacitor, the method including: a first connection step of connecting two or more first internal leads to a first electrode foil; a second connection step of, after the first connection step, connecting the two or more first internal leads to a first external lead, to obtain the first electrode; an insertion step of, after the second connection step, inserting the first external lead into an insertion hole of a sealing member; a housing step of, after the insertion step, housing the first electrode and the second electrode into a container; and a sealing step of, after the housing step, sealing an opening of the container with the sealing member; wherein the two or more first internal leads each have a through-hole, the first external lead has a columnar part having a maximum diameter larger than a maximum diameter of the through-hole, the columnar part has a first portion including one end of the columnar part, a second portion continuous with the first portion, and a third portion continuous with the second portion and not passing through the insertion hole in the insertion step, and the second connection step includes, in a stacked part in which a part of each of the two or more first internal leads is overlapped with each other, inserting the columnar part into the through-holes, and after protruding the first portion from a first surface of the stacked part, crushing the first portion against the first surface of the stacked part, to form a top part crimped onto the first surface, and to engage the second portion with an inner peripheral surface of the stacked part.

### Advantageous Effects of Invention

According to the present disclosure, it is possible to increase the allowable ripple current of an electrolytic capacitor.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic plan view of a first electrode foil with a first internal lead connected thereto, a second electrode foil with a second internal lead connected thereto, and a separator, which are arranged in a stacked order.

FIG. 2 An oblique view schematically illustrating a step of connecting an external lead to internal leads.

FIGS. 3A to 3D Sectional schematic diagrams explaining a second connection step of connecting an external lead to internal leads.

FIG. 4 A side view of a wound body after a second connection step.

FIG. 5 A side view of a wound body after an insertion step.

FIG. 6 A side view illustrating in section a bottomed case and a sealing member of an electrolytic capacitor.

FIGS. 7A to 7C Partial schematic diagrams of an external lead showing variations of a flange part.

FIGS. 8A to 8D Sectional schematic diagrams explaining another example of the second connection step of connecting an external lead to internal leads.

### DESCRIPTION OF EMBODIMENTS

Embodiments of the electrolytic capacitor according to the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” means to include the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The “electrolytic capacitor” may be rephrased as a “solid electrolytic capacitor” or a “solid-liquid hybrid electrolytic capacitor,” and the “capacitor” may be rephrased as a “condenser”. The “conductive polymer” forms at least part of the solid electrolyte layer.

### Electrolytic Capacitor

An electrolytic capacitor according to one embodiment of the present disclosure includes a first electrode, a second electrode, a container housing the first electrode and the second electrode, and a sealing member closing the opening of the container. The first electrode and the second electrode are components constituting a capacitor element. The first electrode and the second electrode may form a wound body. In the wound body, a separator can be interposed between the first electrode and the second electrode. The wound body can include a solid electrolyte.

The container may be a bottomed case housing a capacitor element. The bottomed case has an opening. The bottomed case includes a tubular part, and a bottom closing one end of the tubular part. The other end (open end) of the tubular part is closed with a sealing member. The outer shape of the bottomed case is, for example, cylindrical or approximately cylindrical. Examples of the material of the bottomed case include a metal, such as aluminum, aluminum alloy, stainless steel, copper, iron, and brass.

The sealing member may be a sealing plate. The sealing member closes the opening of the bottomed case. The sealing member can have one or more insertion holes for inserting an external lead therethrough. The sealing member may be any material that is electrically insulative, but preferably includes a rubber member. The rubber member has elasticity. Therefore, when the external lead is inserted into the sealing member, the damages to the external lead and the sealing member are both suppressed. The international rubber hardness (IRHD) of the rubber member is, for example, 70 to 99, and may be 80 to 95.

Examples of an elastic polymer constituting the rubber member include silicone rubber, fluorine-containing rubber, ethylene propylene rubber, chlorosulfonated polyethylene rubber (Hypalon rubber, etc.), butyl rubber, isoprene rubber, and isobutyl-isoprene rubber. In particular, from the viewpoint of heat resistance, fluorine-containing rubber is preferred.

The first electrode and the second electrode may be electrodes having different polarities. One of the first electrode and the second electrode may be an anode member having a dielectric film formed at its surface, and the other may be a cathode member. When the first electrode is an anode member (cathode member), the second electrode is a cathode member (anode member).

The first electrode functions, for example, as an anode member. In this case, the first electrode can include a first electrode foil (anode foil) containing at least one valve metal, such as titanium, tantalum, aluminum, and niobium. The thickness of the anode foil is, for example, 15 μm or more and 300 μm or less.

The surface of the anode foil may be roughened by etching or the like. A dielectric film may be formed on the surface of the anode foil. The dielectric film is formed, for example, by subjecting the first electrode to chemical conversion treatment. In this case, the dielectric film can contain an oxide of the valve metal. The dielectric film is not limited thereto, and may be any material that functions as a dielectric.

The second electrode functions, for example, as a cathode member. In this case, the second electrode can include a second electrode foil (cathode foil). The cathode foil, like the first electrode foil, may be made of a valve metal, and may be made of a metal such as iron (Fe) or copper (Cu). The thickness of the cathode foil is, for example, 15 μm or more and 300 μm or less.

The surface of the cathode foil may be roughened, or subjected to chemical conversion treatment, as necessary. Also, on the surface of the cathode foil, an inorganic layer including carbon, nickel, titanium, an oxide or nitride thereof, or the like may be formed.

The first electrode has a first electrode foil, two or more first internal leads connected to the first electrode foil, and a first external lead connected to the two or more first internal leads. Likewise, the second electrode can have a second electrode foil, two or more second internal leads connected to the second electrode foil, and a second external lead connected to the two or more second internal leads. Hereinafter, the first internal lead and the second internal lead may be collectively referred to as an “internal lead”. The first external lead and the second external lead may be collectively referred to as an “external lead”.

The internal lead is foil-shaped. The internal lead has a thickness of, for example, 15 μm or more and 300 μm or less. The material of the internal lead can be, for example, aluminum, titanium, nickel, copper, iron, tantalum, niobium, or an alloy thereof.

The external lead is used to draw the electrode to the outside. The external lead may be rod-shaped, and has a rigidity sufficient to be inserted into the sealing member. The material of the external lead can be, for example, aluminum, titanium, nickel, copper, iron, tantalum, niobium, or an alloy thereof. The materials of the internal lead and the external lead at the connection portion therebetween are preferably the same as each other.

A part of each of the two or more first internal leads is overlapped with each other, forming a stacked part (first stacked part). Likewise, a part of each of the two or more second internal leads is overlapped with each other, forming a stacked part (second stacked part). Hereinafter, the first stacked part and the second stacked part may be collectively referred to as a “stacked part”.

The external lead has a first portion, a second portion continuous with the first portion, and a third portion continuous with the second portion. Note that the first portion, the second portion, and the third portion are continuous with each other, and therefore, necessarily have no clear boundary therebetween.

The first portion of the external lead has a top part crimped onto a first surface of the first stacked part. The second portion of the external lead is penetrated through the stacked part. The third portion of the external lead is protruded from a second surface opposite to the first surface of the stacked part, and is penetrated through the sealing member. The second portion of the external lead is in contact with the inner peripheral surface of the stacked part.

It is preferable that, on the inner peripheral surface of the stacked part, respective inner peripheral surfaces of the two or more internal leads are displaced from the second surface side toward the first surface side. Such a structure is very effective for sufficiently reducing the connection resistance between the internal leads and the external lead. The above structure is formed, when the external lead penetrates through the stacked part, as a large frictional resistance occurs between the respective inner peripheral surfaces of the internal leads and the outer peripheral surface of the external lead (in other words, the outer peripheral surface of the second portion). In other words, the above structure means an ensured electrical connection obtained by the sufficient engagement between the respective inner peripheral surfaces of the internal leads and the outer peripheral surface of the second portion of the external lead.

A vicinity of the inner peripheral surface of the internal lead (hereinafter sometimes referred to as the “internal lead (1)”) located closest to the first surface side of the stacked part is preferably protruded toward the first surface side from the second surface side and folded back onto the first surface. Such a structure is very effective for sufficiently reducing the connection resistance between the internal leads and the external lead. The above structure is formed, when the external lead penetrates through the stacked part, by, after at least the vicinity of the inner peripheral surface of the internal lead (1) is protruded toward the first surface side from the second surface side, folding the protruded portion back onto the first surface, and pressing it against the first surface. In other words, the above structure means an ensured electrical connection obtained by the sufficient engagement between the internal lead (1) and the third portion of the external lead. The distance from the fold on the inner side formed when folded back, to the furthest position of the folded back portion is preferably 100 μm or more, and more preferably 500 μm or more.

The above-described structures also have an aspect of increasing the denseness of the connection portion between the stacked part and the external lead, and improving the conductivity. The denseness becomes more difficult to be ensured as the thickness of the stacked part (in other words, the internal leads) decreases. On the other hand, the requirements for electrolytic capacitors are increasingly getting stricter, and there is a tendency to require to achieve both a reduction in size and an increase in the allowable ripple current, which are contradictory characteristics. In this case, it can be very important to use a thin internal lead, and increase the denseness of the connection portion between the stacked part and the external lead.

In light of the demand for a reduction in size of electrolytic capacitors, the thickness of each internal lead is preferably 0.2 mm or less, more preferably 0.15 mm or less.

From the above circumstances, a total thickness Tx of the first and second portions of the external lead can be, for example, 2.0 mm or less.

From the viewpoint of highly increasing the denseness of the connection portion between the stacked part and the external lead, the maximum height of the first portion of the external lead from the first surface is preferably 0.5 mm or less, may be 0.3 mm or less, may be 0.2 mm or less, and may be 0.1 mm or less. In other words, on appearance, it is preferable that the connection portion between the stacked part and the external lead is approximately flush with the surrounding stacked part.

From the view point of highly increasing the denseness of the connection portion between the stacked part and the external lead, the maximum diameter of the first portion of the external lead as viewed from the first surface side (i.e., the maximum diameter of the top part crimped onto the first surface of the stacked part) may be 110% or more of the maximum diameter of the third portion (the columnar part excluding the flange part). In this case, it can be said that the volume of the first portion that is to be deformed by the crimping is sufficiently secured. This is likely to result in a state where the first portion is largely deformed to be sufficiently engaged with the internal lead (1), and the inner peripheral surface of the first stacked part is engaged with the second portion without any clearance therebetween.

A total thickness Ty of the two or more internal leads may be 10% or more and 90% or less of the Tx. The total thickness Ty can be rephrased as a total thickness before the stacked part is deformed for connection with the external lead.

The external lead may have a flange part contacting the second surface, at a portion continuous with the second portion in the third portion. Such a flange part is useful, when connecting the stacked part and the external lead with each other, for applying a compressive stress to the connection portion. Specifically, the rim of the stacked part continuous with the inner peripheral surface thereof is sandwiched between the flange part provided in the third portion of the external lead and a flange-like portion in the top part formed by deformation of the first portion, and compressed.

The flange part may have a plurality of protrusions or irregularities, at positions in contact with the second surface. This increases the contact area between the flange part and the second surface, which is likely to reduce the connection resistance. Also, this produces an anchor effect, which can improve the strength of the connection portion. Thus, the ESR can be stabilized over a long time.

In an electrolytic capacitor according to one embodiment of the present disclosure, a conductive polymer may be attached to at least one of the first electrode foil and the second electrode foil. The conductive polymer constitutes a solid electrolyte layer. When the first electrode is an anode member and the second electrode is a cathode member, the first electrode foil is an anode foil having a dielectric film formed on its surface. In this case, the solid electrolyte layer covers at least part of the dielectric film and is interposed between the anode member and the cathode member. A separator may be disposed between the anode member and the cathode member. According to such a structure, the ESR of the capacitor element can be sufficiently reduced, and therefore, the allowable value of the ripple current can be significantly increased. On the other hand, with increasing the allowable value of the ripple current, it becomes more important to sufficiently reduce the connection resistance between the internal lead and the external lead by adopting the configuration of the present disclosure. This is because, in the case of significantly increasing the allowable value of the ripple current, it is required to suppress the heat generation due to the connection resistance between the internal lead and the external lead.

The separator is not particularly limited as long as it is porous. Examples of the separator include nonwoven fabric made of cellulose fibers, nonwoven fabric made of glass fibers, and a microporous film, woven fabrics, and nonwoven fabrics made of polyolefin. The thickness of the separator is, for example, 10 μm or more and 500 μm or less.

As the conductive polymer, for example, a z-conjugated polymer can be used. Examples of the I-conjugated polymer include polypyrrole, polythiophene, polyfuran, polyaniline, and a derivative thereof. The derivative means a polymer whose basic backbone is polypyrrole, polythiophene, polyfuran, polyaniline, or the like. For example, a polythiophene derivative encompasses poly(3,4-ethylenedioxythiophene) (PEDOT), and the like. These may be used singly or in combination of two or more kinds, and may be a copolymer of two or more kinds of monomers. The weight average molecular weight of the conductive polymer is, although not particularly limited to, for example, 1000 to 100,000.

The solid electrolyte layer may include a T-conjugated polymer and a dopant. From the viewpoint of suppressing the de-doping of the dopant from the conductive polymer, the solid electrolyte layer desirably includes a polymer dopant. Examples of the polymer dopant include anions of polyvinyl sulfonic acid, polystyrene sulfonic acid, polyallyl sulfonic acid, polymethacryl sulfonic acid, poly(2-acrylamide-2-methylpropane sulfonic acid), polyisoprene sulfonic acid, and polyacrylic acid. These may be used singly or in combination of two or more kinds. These may be in the form of a homopolymer or a copolymer of two or more kinds of monomers. Preferred among them is polystyrene sulfonic acid (PSS). The weight-average molecular weight of the polymer dopant is, although not particularly limited to, preferably, for example, 1,000 to 500,000, in terms of ease of forming a homogeneous solid electrolyte layer.

The solid electrolyte layer may be formed by impregnating at least one of the first electrode foil and the second electrode foil with a predetermined processing liquid. The processing liquid may be a solution of a conductive polymer dissolved in a solvent, or a dispersion of a conductive polymer dispersed in a solvent (dispersion medium). Thereafter, the solvent is evaporated from the conductive polymer attached to at least one of the first electrode foil and the second electrode foil.

The concentration of the conductive polymer contained in the processing liquid is preferably, for example, 0.5 to 10 mass %. The average particle diameter D50 of the conductive polymer is preferably, for example, 0.01 to 0.5 μm. Here, the average particle diameter D50 is a median diameter in a volumetric particle size distribution obtained by a particle size distribution analyzer using a dynamic light scattering method.

The processing liquid can be obtained by, for example, a method of dispersing a conductive polymer in a solvent, a method of polymerizing a precursor monomer in a solvent to produce particles of a conductive polymer, and other methods. A preferred processing liquid is, for example, poly(3,4-ethylenedioxythiophene) (PEDOT) doped with polystyrene sulfonic acid (PSS), i.e., PEDOT/PSS.

The solvent may be at least one of water and a nonaqueous solvent. The nonaqueous solvent may be a protic solvent, and may be an aprotic solvent. Considering the stable dispersibility of the conductive polymer, the solvent may contain 50 mass % or more of water.

At least one of the first electrode foil and the second electrode foil may be impregnated with a liquid component. In this case, the electrolytic capacitor is a solid-liquid hybrid electrolytic capacitor. The solid-liquid hybrid electrolytic capacitor is suitable for applications that require a relatively large current to flow because a reduction in ESR can be easily realized by the solid electrolyte layer, and the repairing effect of the dielectric film of the anode foil exerted by the liquid component is high. In other words, in the solid-liquid hybrid electrolytic capacitor, a highest possible allowable ripple current is desirable. For improving the allowable ripple current of the solid-liquid hybrid electrolytic capacitor, the effect of achieving low ESR by reducing the connection resistance makes a great contribution. Note that achieving low ESR by reducing the connection resistance includes the heat generation suppression effect obtained by achieving low ESR (esp., the effect of suppressing heat generation due to the connection resistance component).

In the electrolytic capacitor according to one embodiment of the present disclosure, the allowable ripple current may be, for example, 0.3 A or more, may be 1.0 A or more, and may be 3.0 A or more.

In the case of allowing a large current to flow, it is desirable that the rated capacitance of the electrolytic capacitor is as high as possible. In the electrolytic capacitor according to one embodiment of the present disclosure, the rated capacitance may be, for example, 3.3 μF or more, may be 10 μF or more, may be 47 μF or more, and may be 560 μF or more, or 1000 μF or more.

The liquid component contains a solvent. As the solvent, a sulfone compound, a lactone compound, a carbonate compound, a polyhydric alcohol, and the like are exemplified. Examples of the sulfone compound include sulfolane, dimethyl sulfoxide, and diethyl sulfoxide. Examples of the lactone compound include γ-butyrolactone, and γ-valerolactone. Examples of the carbonate compound include dimethyl carbonate (DMC), diethyl carbonate (DEC), ethyl methyl carbonate (EMC), ethylene carbonate (EC), propylene carbonate (PC), and fluoroethylene carbonate (FEC). Examples of the polyhydric alcohol include: glycol compounds, such as ethylene glycol (EG), diethylene glycol, triethylene glycol, propylene glycol, and polyethylene glycol (PEG); and glycerin. These may be used singly or in combination of two or more kinds. This significantly suppresses the evaporation of the liquid component, and suppresses the deterioration of the conductive polymer, especially during reflowing and during use from the early to middle stages. Thus, the allowable value of the ripple current can be easily increased.

The solvent may include a compound having two or more hydroxy groups. Examples of such a compound include polyhydric alcohols. The content amount of the compound having two or more hydroxy groups may be 50 mass % or more, may be 60 mass % or more, and may be 70 mass % or more of the whole solvent.

The liquid component may further contain an acid component. In the case where a conductive polymer and a dopant are attached in the electrolytic capacitor, the acid component in the liquid component can suppress the de-doping phenomenon of the dopant and stabilize the conductivity of the conductive polymer. Moreover, even when the dopant is de-doped from the conductive polymer, since the acid component in the liquid component is re-doped into the site from which the dopant has been de-doped, the ESR can be easily kept low. In terms of enhancing the effect of suppressing the de-doping phenomenon, the concentration of the acid component may be 5 mass % or more and 50 mass % or less, and may be 15 mass % or more and 35 mass % or less.

The liquid component may contain a base component in addition to the acid component. The base component neutralizes the acid component at least partially. This can suppress the corrosion of the electrode due to the acid component, while increasing the concentration of the acid component. From the view point of effectively suppressing the de-doping phenomenon, the acid component is preferably in excess than the base component, in terms of the equivalent ratio. For example, the equivalent ratio of the acid component to the base component may be 1 or more and 30 or less. The concentration of the base component contained in the liquid component may be 0.1 mass % or more and 20 mass % or less, and may be 3 mass % or more and 10 mass % or less.

The pH of the liquid component is preferably 4 or less, more preferably 3.8 or less, and further more preferably 3.6 or less. By setting the pH of the liquid component to 4 or less, the deterioration of the conductive polymer can be further suppressed. The pH is preferably 2.0 or more.

### Method of Producing Electrolytic Capacitor

A method of producing an electrolytic capacitor according to an embodiment of the present disclosure includes a first connection step, a second connection step, an insertion step, a housing step, and a sealing step.

In the first connection step, two or more first internal leads are connected to a first electrode foil. In the first connection step, two or more second internal leads may be connected to a second electrode foil.

In the second connection step, the two or more first internal leads are connected to a first external lead. As a result, a first electrode having a first electrode foil, two or more first internal leads connected to the first electrode foil, and a first external lead connected to the two or more first internal leads can be obtained. The second connection step is performed after the first connection step.

In the second connection step, two or more second internal leads may be connected to a second external lead. As a result, a second electrode having a second electrode foil, two or more second internal leads connected to the second electrode foil, and a second external lead connected to the two or more second internal leads can be obtained.

The two or more internal leads may each have a through-hole. In that case, the first external lead has a columnar part having a maximum diameter larger than a maximum diameter of the through-hole. The columnar part is, for example, cylindrical in shape, and the diameter (maximum diameter when the cross section is not a perfect circle) thereof is, for example, 1 mm to 2.5 mm, and may be 1.5 mm to 2 mm. The diameter of the columnar part may be, for example, 100% to 200% or 110% to 200% of the maximum diameter of the through-hole.

The columnar part of the external lead has a first portion including one end of the columnar part, a second portion continuous with the first portion, and a third portion continuous with the second portion and not passing through the insertion hole in the insertion step.

In the second connection step, in a stacked part in which a part of each of the two or more internal leads is overlapped with each other, the columnar part is inserted into the through-holes. After the first portion is protruded from a first surface of the stacked part, the first portion is crushed against the first surface of the stacked part. In this way, a top part crimped onto the first surface is formed, and the second portion is engaged with the inner peripheral surface of the stacked part.

In the second connection step, for example, into the through-holes of the internal leads extending in a first direction, the columnar part of the external lead extending in a second direction intersecting the first direction is inserted.

In the insertion step, the external lead (more specifically, the third portion of the external lead) is inserted into the insertion hole of a sealing member. The insertion step is performed after the second connection step.

In the insertion step, after the direction in which the stacked part extends is oriented in the second direction, and the direction in which the external lead extends is oriented in the first direction, the third portion of the columnar part may be inserted into the sealing member.

In the housing step, the first electrode and the second electrode are housed into a container (e.g., a bottomed case). The first electrode and the second electrode may form a wound body. The wound body can include a separator interposed between the first electrode and the second electrode. The wound body can include a solid electrolyte containing a conductive polymer. In the housing step, a liquid component may be housed together with the wound body, into the container. The housing step is performed after the insertion step.

In the sealing step, the opening of the container is closed with the sealing member. The sealing step is performed after the housing step. Before the sealing step, a step of attaching a conductive polymer to the first electrode foil and the second electrode foil may be performed. Also, before the sealing step, at least one of the first electrode foil and the first electrode foil may be impregnated with a liquid component.

In the following, an electrolytic capacitor according to one embodiment of the present disclosure and a method for producing the same will be described with reference to the drawings. The present disclosure, however, is not limited to the below. Hereinafter, when the first electrode is an anode member (cathode member), the second electrode is a cathode member (anode member).

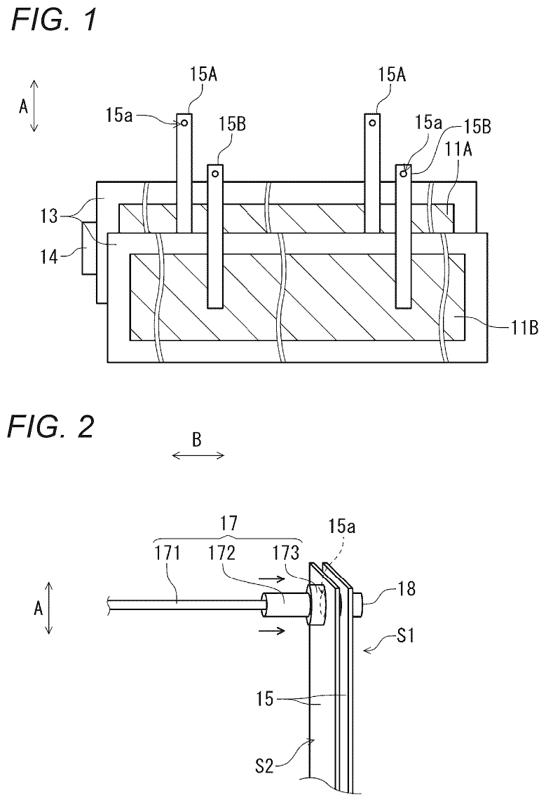

FIG. 1 is a schematic plan view of a first electrode foil 11A with first internal leads 15A connected thereto by the first connection step, a second electrode foil 11B with second internal leads 15B connected thereto by the first connection step, and a separator 13 interposed between the first electrode foil 11A and the second electrode foil 11B, which are arranged in a stacked order. In FIG. 1, two or more first internal leads 15A are connected to the first electrode foil 11A, and two or more second internal leads 15B are connected to the second electrode foil 11B. Thereafter, the first electrode foil 11A and the second electrode foil 11B are wound with the separator 13 interposed therebetween. Usually, the separator 13 is arranged at the outermost layer of a wound body 10, and the end of the winding is stopped with a winding stop tape 14. The longitudinal direction of each internal lead is parallel to the winding axis direction (arrow A).

FIG. 2 is an oblique view schematically illustrating a step of connecting an external lead 17 to internal leads 15. A through-hole 15a is formed at one end of each of the internal leads. The external lead 17 has a lead main body part 171, a columnar part 172, and a flange part 173. At part of the internal leads 15A (at tip ends thereof), a stacked part is formed such that the through-holes 15a overlap each other. The columnar part 172 of the external lead 17 is inserted into the through-holes 15a from the second surface S2 side of the stacked part. The portion protruding from the first surface S1 of the stacked part is a first portion 18 that is to be crushed. At this time, the direction in which the internal leads extend corresponds to the first direction (arrow A), and the direction in which the external lead 17 extends corresponds to the second direction (arrow B). Thereafter, the first portion 18 of the external lead 17 is pressed so as to be pushed against the flange part 173, to crush the first portion 18. As a result, the external lead 17 is fixed to the internal leads 15 and connected thereto. The material of the lead main body part 171 is nickel, copper, iron, or an alloy thereof, and may be applied with plating on its surface. The materials of the columnar part 172 and the flange part 173 are preferably a valve metal, such as aluminum, titanium, tantalum, niobium, or an alloy thereof. In light of the adhesion to the internal leads 15, aluminum is most preferable.

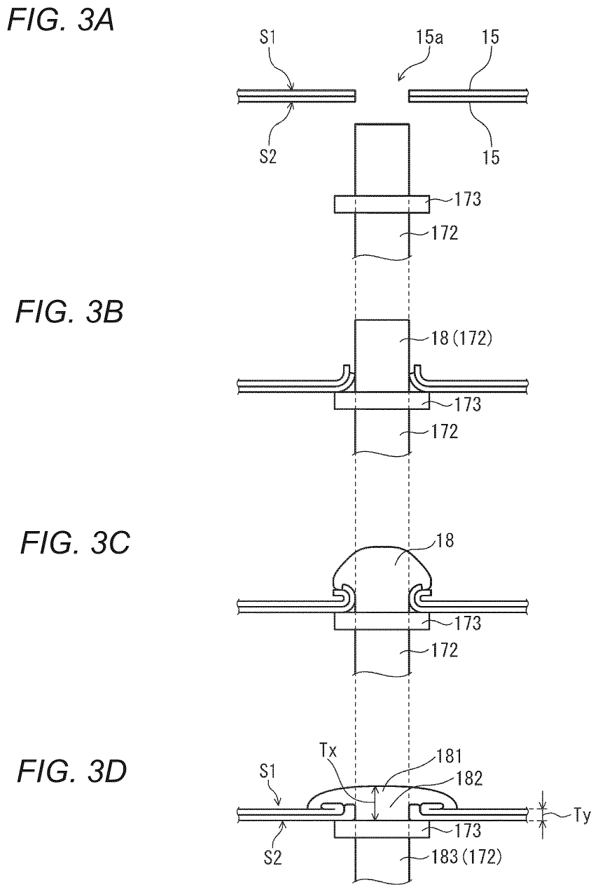

FIGS. 3A to 3D are sectional schematic diagrams explaining the second connection step of connecting the external lead 17 to the internal leads 15. FIG. 3A illustrates, in a stacked part where a part of each of the two internal leads 15 is overlapped with each other, how the columnar part 172 of the external lead 17 is inserted into the through-holes 15a arranged to communicate with each other. The columnar part 172 is cylindrical, and the through-holes 15a are circular. The diameter of the columnar part 172 is larger than the diameter of the through-holes 15a, and is 100% to 200% or 110% to 200% of the diameter of the through-holes.

As illustrated in FIG. 3A, a portion defining the inner peripheral surface of the stacked part or the through-holes 15a of the internal leads 15 is pushed up by the columnar part 172 and plastically deforms so as to enlarge the diameter of the through-holes 15a. This causes the inner peripheral surfaces of the through-holes 15a to be displaced from the second surface S2 side toward the first surface S1 side. Also, at least in the internal lead 15 located closest to the first surface S1, the vicinity of the inner peripheral surface of the through-hole 15a is protruded toward the first surface S1 side from the second surface S2 side.

Then, the first portion 18 protruding from the first surface S1 of the stacked part is crushed toward the first surface S1 of the stacked part. At that time, as shown in FIG. 3C, the vicinity of the inner peripheral surface of the internal lead 15 which has been protruded toward the first surface S1 side is folded back onto the first surface S1.

In the process during which the first portion 18 deforms, the first portion 18 changes into a top part 181 having a flange-like portion, and the vicinity of the inner peripheral surface of the stacked part sandwiched between the top part 181 and the flange part 173 is compressed. In this way, the top part 181 is crimped onto the first surface S1, and a second portion 182 of the columnar part 172 is engaged with the inner peripheral surface of the stacked part. When the crushing of the first portion 18 is completed, the columnar part 172 of the external lead 17 changes into the top part 181, the second portion 182 penetrated through the stacked part, and a third portion 183 protruding from the second surface of the stacked part. The second portion 182 comes in dense contact with the inner peripheral surface of the stacked part.

FIG. 3D shows an example of the total thickness Tx of the first and second portions of the external lead. The Tx can be, for example, 2.0 mm or less. The total thickness Ty of two or more internal leads is, for example, 10% to 90% of the Tx.

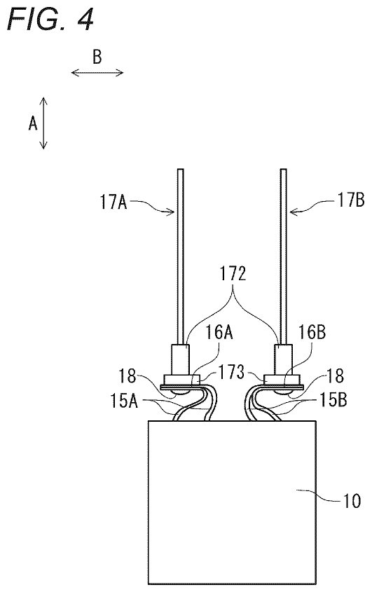

FIG. 4 is a side view of the wound body 10 having a first connection portion 16A where a first external lead 17A is connected to first internal leads 15A, and a second connection portion 16B where a second external lead 17B is connected to second internal leads 15B.

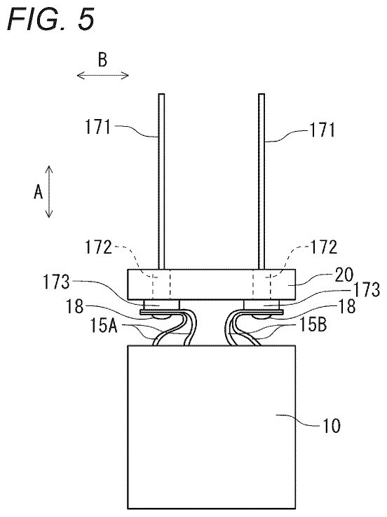

FIG. 5 is a side view of the wound body 10 after the insertion process.

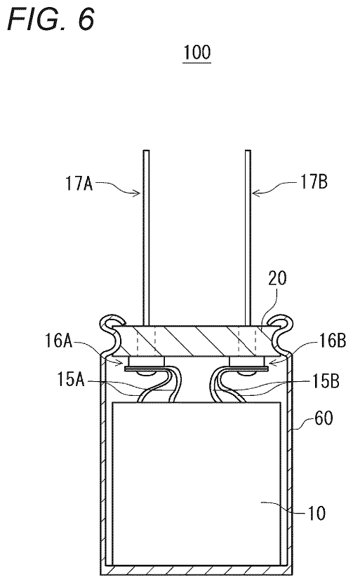

FIG. 6 is a side view illustrating in section a bottomed case 60 and a sealing member 20 of a completed electrolytic capacitor 100.

Note that the insertion step is performed, as described above, after the direction in which the stacked part (i.e., the first connection portion 16A and the second connection portion 16B) extends is oriented in the second direction (arrow B), and the direction in which the first external lead 17A and the second external lead 17B extend is oriented in the first direction (arrow A).

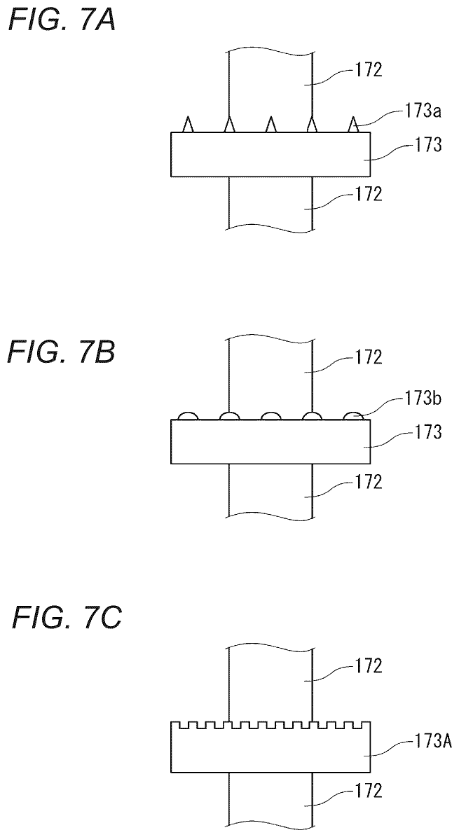

FIGS. 7A to 7C are partial schematic diagrams of the side surface of the external lead 17 showing variations of the flange part. In FIG. 7A, a plurality of pointed protrusions 173a are provided on the surface of the flange part 173 facing the second surface S2 of the stacked part. In FIG. 7B, which is a modified example of the above, a plurality of spherical protrusions 173b are provided on the surface of the flange part 173 facing the second surface S2 of the stacked part. FIG. 7C shows a flange part 173A having a plurality of irregularities on the surface facing the second surface S2 of the stacked part. All of these flange parts are useful for reducing the connection resistance between the external lead and the internal leads and for more remarkably increasing the allowable value of the ripple current.

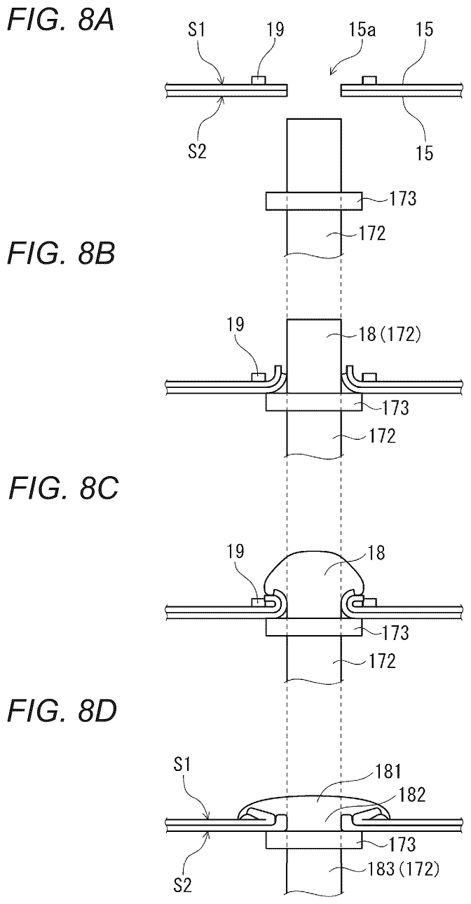

FIGS. 8A to 8D are schematic diagrams explaining another example of the second connection step of connecting the external lead to the internal leads, which is a modified example of the second connection step described with reference to FIGS. 3A to 3D. Here, a washer 19 is used. The washer 19 is disposed on the first surface S1 of the stacked part so as to surround the rim of the through-hole 15a. As shown in FIG. 8A, the portion defining the inner peripheral surface of the stacked part or the through-holes 15a of the internal leads 15 is pushed up by the columnar part 172 and plastically deforms so as to expand the diameter of the through-holes 15a. Also, at least in the internal lead 15 located closest to the first surface S1, the vicinity of the inner peripheral surface of the through-hole 15a is protruded toward the first surface S1 side from the second surface S2 side.

Then, the first portion 18 protruding from the first surface S1 of the stacked part is crushed toward the first surface S1 of the stacked part. At that time, as shown in FIG. 8C, the vicinity of the inner peripheral surface of the internal lead 15 which has been protruded toward the first surface S1 is folded back onto the first surface S1 with the washer 19 interposed therebetween. By interposing the washer 19, the compressive stress near the inner peripheral surface of the stacked part in the process during which the first portion 18 deforms is significantly increased. As shown in FIG. 8D, when the crushing of the first portion 18 is completed, and the top part 181 resulted from the deformation of the first portion 18, the second portion 182 penetrated through the stacked part, and the third portion 183 protruding from the second surface of the stacked part are formed, the second portion 182 comes in highly dense contact with the inner peripheral surface of the stacked part.

### INDUSTRIAL APPLICABILITY

The present disclosure is applicable to electrolytic capacitors. In particular, it is suitably applicable to electrolytic capacitors (e.g., solid-liquid hybrid electrolytic capacitors) used in applications for which low ESR and improvement in allowable ripple current are required.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

100 electrolytic capacitor
   10 wound body
   11A first electrode foil
   11B second electrode foil
   13 separator
   14 winding stop tape
   15A first internal lead
   15B second internal lead
      15a through-hole
   16A first connection portion
   16B second connection portion
   17A first external lead
   17B second external lead
      171 lead main body part
      172 columnar part
      173, 173A flange part
         173a, 173b protrusion
   18 first portion
      181 top part
      182 second portion
      183 third portion
   20 sealing member
   60 bottomed case

1. An electrolytic capacitor, comprising:
a first electrode,
a second electrode,
a container housing the first electrode and the second electrode, and
a sealing member closing an opening of the container, wherein:
the first electrode has a first electrode foil, two or more first internal leads connected to the first electrode foil, and a first external lead connected to the two or more first internal leads;
a part of each of the two or more first internal leads is overlapped with each other, forming a stacked part;
the first external lead has a first portion, a second portion continuous with the first portion, and a third portion continuous with the second portion;
the first portion has a top part crimped onto a first surface of the stacked part;
the second portion is penetrated through the stacked part;
the third portion is protruded from a second surface opposite to the first surface of the stacked part and penetrated through the sealing member; and
the second portion is in contact with an inner peripheral surface of the stacked part.

2. The electrolytic capacitor according to claim 1, wherein on the inner peripheral surface of the stacked part, respective inner peripheral surfaces of the two or more first internal leads are displaced from the second surface side toward the first surface side.

3. The electrolytic capacitor according to claim 2, wherein a vicinity of the inner peripheral surface of the first internal lead located closest to the first surface side of the stacked part is protruded toward the first surface side from the second surface side and folded back onto the first surface.

4. The electrolytic capacitor according to claim 1, wherein a total thickness Tx of the first portion and the second portion of the first external lead is 2 mm or less.

5. The electrolytic capacitor according to claim 1, wherein a maximum height of the first portion of the first external lead from the first surface is 0.5 mm or less.

6. The electrolytic capacitor according to claim 1, wherein a maximum diameter of the first portion of the first external lead as viewed from the first surface side is 110% or more of a maximum diameter of the third portion.

7. The electrolytic capacitor according to claim 4, wherein a total thickness Ty of the two or more first internal leads is 10% to 90% of the Tx.

8. The electrolytic capacitor according to claim 1, wherein a flange part contacting the second surface is provided, at a portion continuous with the second portion in the third portion.

9. The electrolytic capacitor according to claim 8, wherein the flange part has a plurality of protrusions or irregularities, at positions in contact with the second surface.

10. The electrolytic capacitor according to claim 1, wherein a conductive polymer is attached to the first electrode foil.

11. The electrolytic capacitor according to claim 1, wherein the first electrode foil is impregnated with a liquid component.

12. The electrolytic capacitor according to claim 1, wherein an allowable ripple current is 0.3 A or more.

13. The electrolytic capacitor according to claim 1, wherein a rated capacitance is 3.3 μF or more.

14. A method for producing an electrolytic capacitor, the method comprising:
a first connection step of connecting two or more first internal leads to a first electrode foil;
a second connection step of, after the first connection step, connecting the two or more first internal leads to a first external lead, to obtain a first electrode;
an insertion step of, after the second connection step, inserting the first external lead into an insertion hole of a sealing member;
a housing step of, after the insertion step, housing the first electrode and a second electrode into a container; and
a sealing step of, after the housing step, sealing an opening of the container with the sealing member; wherein
the two or more first internal leads each have a through-hole,
the first external lead has a columnar part having a maximum diameter larger than a maximum diameter of the through-hole,
the columnar part has a first portion including one end of the columnar part, a second portion continuous with the first portion, and a third portion continuous with the second portion and not passing through the insertion hole in the insertion step, and
the second connection step includes, in a stacked part in which a part of each of the two or more first internal leads is overlapped with each other, inserting the columnar part into the through-holes, and after protruding the first portion from a first surface of the stacked part, crushing the first portion against the first surface of the stacked part, to form a top part crimped onto the first surface, and to engage the second portion with an inner peripheral surface of the stacked part.

15. The method for producing an electrolytic capacitor according to claim 14, wherein in the second connection step, into the through-holes of the first internal leads extending in a first direction, the columnar part of the first external lead extending in a second direction intersecting the first direction is inserted.

16. The method for producing an electrolytic capacitor according to claim 15, wherein in the insertion step, after a direction in which the stacked part extends is oriented in the second direction, and a direction in which the first external lead extends is oriented in the first direction, the third portion of the columnar part is inserted into the sealing member.

17. The method for producing an electrolytic capacitor according to claim 14, further comprising a step of, before the sealing step, attaching a conductive polymer to the first electrode foil.

18. The method for producing an electrolytic capacitor according to claim 14, further comprising a step of, before the sealing step, impregnating the first electrode foil with a liquid component.
